(19) United States
(12) Patent Application Publication
(10) Pub. No.: US 2007/0188522 A1
(43) Pub. Date: Aug. 16, 2007

(54) MIXED REALITY DISPLAY SYSTEM

(75) Inventor: Takashi Tsuyuki, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/671,695

(22) Filed: Feb. 6, 2007

(30) Foreign Application Priority Data
Feb. 15, 2006 (JP) 2006-038154

(51) Int. Cl. G09G 5/00

(52) U.S. Cl. 345/632

(57) ABSTRACT

In a mixed reality display system having a video see-through HMD (head mounted display) and a virtual-space image generation unit, a synthesis processing unit for synthesizing a virtual-space image generated by the virtual-space image generation unit and an image captured by the video see-through HMD is provided on the side of the video see-through HMD, and a part of the captured image is transmitted to the virtual-space image generation unit for detecting a marker, so that a communication amount between the virtual-space image generation unit and the video see-through HMD is reduced.

### BACKGROUND OF THE INVENTION

1. Field of the Invention

The present invention relates to a display system which is suitable in case of displaying on a display unit a synthesized (merged or composited) image acquired by synthesizing (merging or compositing) a real-space image shot by a video camera or the like with a virtual-space image such as a computer graphics (CG) or the like and observing the displayed synthesized image.

2. Description of the Related Art

In recent years, various kinds of display systems which utilize mixed reality that a real-space image acquired by shooting in a real space and a virtual-space image such as a CG or the like are synthesized and displayed have been proposed (e.g., Japanese Patent Application Laid-Open No. H06-268943; and Japanese Patent Application Laid-Open No. 2003-215494 (corresponding to United States Publication No. 2003/0137524 A1)).

In the display system which utilizes the mixed reality, the images are synthesized by a video see-through HMD (head mounted display) having an imaging unit and a display unit.

Here, when the images are synthesized, the real-space image which includes a marker acting as the basis for the image synthesis is captured by the imaging unit provided on the video see-through HMD to generate captured image data, and the generated image data is transmitted to a virtual-space image generation device such as a computer or the like.

Then, the marker included in the transmitted image data is detected by the virtual-space image generation device, and the virtual-space image generated by using the size and position coordinates of the detected marker is synthesized with the real-space image. Subsequently, the synthesized image is transmitted to the display unit of the video see-through HMD, thereby achieving the display system which utilizes the mixed reality.

In Japanese Patent Application Laid-Open No. H06-268943, video in a real image captured by a video camera is dissolved, the dissolved video and a computer graphics are synthesized by an image synthesis device provided on the side of the video see-through HMD, and the synthesized image thus acquired is observed.

Moreover, in Japanese Patent Application Laid-Open No. 2003-215494, a mixed reality presenting apparatus which can correct a registration error of the real-space image and the virtual-space image caused by a time delay when synthesizing these images.

It should be noted that, in the video see-through HMD or a binocular display which is used in the display system which utilizing the mixed reality, a real time property and reality are attached to importance.

For this reason, since a high-resolution display image having a wide angle of view and a high-resolution captured image are required, the capacity of the image data to be processed increases.

To cope with such an increase of the capacity of the image data, a method of compressing the image data is conceived. However, as one of video data compression systems, each of an MPEG (Motion Picture Experts Group) compression system and a Motion-JPEG (Motion Joint Photographic Experts Group) system of compressing video data for each frame requires a time for extracting the compressed data. Further, image compression technique that causes large delay and image compression technique which causes image quality deterioration due to noises and the like are not suitable in the points of real time property and reality.

Furthermore, under existing conditions, although a computer capable of executing a high-speed operation is used as the virtual-space image generation device for creasing the virtual-space image, the relevant computer has the size and weight that a user cannot easily carry. For this reason, it is currently difficult to incorporate in compact the relevant computer into the video see-through HMD.

Therefore, it is necessary to manage and handle not-compressed image data between the video see-through display such as the video see-through HMD and the virtual space image generation device.

At that time, since it is necessary to transfer all the image data of the captured images (real-space images) and the synthesized images (virtual-space images), the number of cables to be used is consequently large if a wireless system is not used. However, in the current wireless system, if it intends to acquire resolution (frequency) at SXGA (Super extended Graphics Array) level that sufficiently satisfies the performance as a mixed reality display system, it is difficult to adopt the wireless system because necessary bands are insufficient in this system.

In general, in case of synthesizing the real-space image and the virtual-space image with each other, the whole image data is computer-processed, the position information of the marker included in the real-space image is detected, and the synthesis is executed by using the detected position information of the marker.

For this reason, there is a problem that a time for transmitting the real-space image and a time for detecting the position information of the marker from the real-space image are prolonged.

### SUMMARY OF THE INVENTION

An object of the present invention is to provide a display system that can appropriately control an amount of data to be transferred among devices even if a captured image is a high-resolution image.

Another object of the present invention is to provide a display system that can detect a marker from a real-space image in a short processing time and thus rapidly synthesize a real-space image and a virtual-space image with each other.

To solve the above-described problem, a display system according to the present invention includes a display device and an image generation device, the display device comprises: an imaging unit adapted to capture a real-space image including a marker, a display unit adapted to display a synthesis image which is acquired by synthesizing the captured real-space image and a virtual-space image generated by the image generation device, and a transmission unit adapted to transmit, to the image generation device, image data which is a part of the captured real-space image and necessary to recognize position information of the marker in a real space, and the image generation device comprises: a reception unit adapted to receive the image data transmitted from the transmission unit, a recognition unit adapted to recognize the marker included in the received image data, an image generation unit adapted to generate the virtual-space image based on a result of the recognition, and an image transmission unit adapted to transmit the generated virtual-space image to the display device.

Further features of the present invention will become apparent from the following description of exemplary embodiments with reference to the attached drawings.

### BRIEF DESCRIPTION OF THE DRAWINGS

FIG. 1 a block diagram illustrating a schematic construction in a first exemplary embodiment of the present invention.

FIG. 2 is a block diagram illustrating an image synthesis processing unit in the first exemplary embodiment of the present invention.

FIG. 3 is a diagram for describing a synthesis control signal in the first exemplary embodiment of the present invention.

FIG. 4 is a diagram illustrating memory spaces in a second exemplary embodiment of the present invention.

FIG. 5 is a block diagram illustrating an image synthesis processing unit in the second exemplary embodiment of the present invention.

### DESCRIPTION OF THE EMBODIMENTS

Hereinafter, exemplary embodiments of the present invention will be described with reference to the attached drawings.

In the following exemplary embodiments, a head mount display (HMD) will be described by way of example to which the present invention is applied. However, the present invention is not limited to this. That is, the present invention is also applicable to a binocular display or the like.

### First Exemplary Embodiment

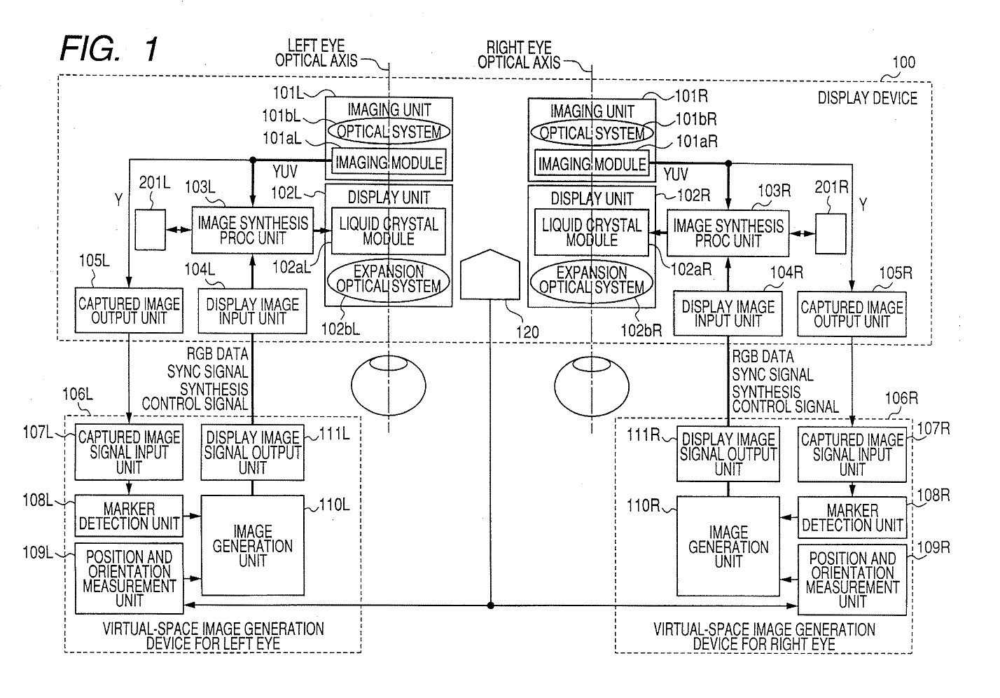

FIG. 1 a block diagram illustrating a schematic construction of the substantial part of a display system in the first exemplary embodiment that utilizes mixed reality.

In the following, the constructions of a head mounted display (or portable display) and a virtual-space image generation device will be first described, and then the operation of an image synthesis process will be described.

In FIG. 1, a head mount display device 100 has an imaging unit 101L for left eye, an imaging unit 101R for right eye, a display unit 102L for left eye, a display unit 102R for right eye, an image synthesis processing unit 103L for left eye, and an image synthesis processing unit 103R for right eye. Also, the head mount display device 100 has a captured image output unit 105L for left eye, a captured image output unit 105R for right eye, a display image input unit 104L for left eye, a display image input unit 104R for right eye, and a position and orientation sensor 120.

For example, the display unit 102L for left eye includes a liquid crystal module 102aL and an expansion optical system 102bL, and the display unit 102R includes a liquid crystal module 102aR and an expansion optical system 102bR.

Thus, an observer observes images on the liquid crystal modules 102aL and 102aR through the expansion optical systems 102bL and 102bR respectively.

Here, it should be noted that each of the liquid crystal modules 102aL and 102aR integrally includes a liquid crystal panel such as a p-SiTFT (poly-Silicon Thin Film Transistor) or an LCOS (Liquid Crystal On Silicon), peripheral circuits thereof, and a light source (back light or front light).

The imaging unit 101L for left eye includes an imaging module 101aL and an optical system (imaging system) 101bL, and the imaging unit 101R for right eye includes an imaging module 101aR and an optical system (imaging system) 101bR. Here, the optical axis of the imaging system 101bL is arranged to coincide with the optical axis of the display unit 102L, and the optical axis of the imaging system 101bR is arranged to coincide with the optical axis of the display unit 102R.

Here, each of the imaging modules 101aL and 101aR includes an imaging device such as a CCD (charge coupled device) or a CMOS (complementary metal oxide semiconductor), a device such as an IC (integrated circuit) for converting an analog signal transmitted from the imaging device into a digital signal such as a YUV signal (i.e., color signal including luminance signal) or the like, and the like.

The image synthesis processing unit 103L synthesizes a real-space image and a virtual-space image based on a synthesis control signal transmitted from a virtual-space image generation device 106L, and also the image synthesis processing unit 103R synthesizes a real-space image and a virtual-space image based on a synthesis image control signal transmitted from a virtual-space image generation device 106R. More specifically, the image synthesis processing unit 103L synthesizes a captured image data signal (real-space image) transmitted from the imaging unit 101L and a generation image signal such as a CG (computer graphics) signal transmitted from the virtual-space image generation device 106L, and also the image synthesis processing unit 103R synthesizes a captured image data or signal (real-space image) transmitted from the imaging unit 101R and a generation image signal such as a CG signal transmitted from the virtual-space image generation device 106R.

Then, the image synthesis processing units 103L and 103R transmit synthesis image signals to the display units 102L and 102R respectively. Here, in a case where the resolution and/or the frame rate of the image transmitted from each of the imaging units 101L and 101R do not coincide with those of an image to be displayed (also called a display image hereinafter), it is possible to provide a frame rate conversion function and/or a scaling function in each of the image synthesis processing units 103L and 103R.

Subsequently, the constitutions of the virtual-space image generation devices 106L and 106R will be described hereinafter.

The virtual-space image generation device 106L includes an image generation unit 110L for generating a virtual-space image signal and a display image signal output unit 111L for outputting the virtual-space image signal, and also the virtual-space image generation device 106R includes an image generation unit 110R and a display image signal output unit 111R. Further, the virtual-space image generation device 106L includes a captured image signal input unit 107L to which the captured image data is input from the head mount display device 100, a marker detection unit 108L for detecting a marker in a real space, and a position and orientation measurement unit 109L. Also, the virtual-space image generation device 106R includes a captured image signal input unit 107R, a marker detection unit 108R, and a position and orientation measurement unit 109R. For example, the above units are all achieved by general-purpose computers or the like.

In particular, a graphic card or the like provided within the computer acts as the display image signal output units 111L and 111R. Then, each of the display image signal output units 111L and 111R converts RGB data signals, and digital signals such as sync signals (vertical sync signal, horizontal sync signal, and clock) and the synthesis control signals into high-speed transmission signals in an LVDS (Low Voltage Differential Signaling) to achieve high-speed signal transmission, and outputs the acquired signals to the side of the head mount display device 100.

Further, it should be noted that a USB (Universal Serial Bus) which is a data transmission path, and an interface (I/F) such as an IEEE (Institute of Electrical and Electronics Engineers) 1394 I/F or the like which is a high-speed serial interface and attached to a general-purpose computer act as each of the captured image signal input units 107L and 107R.

An output signal is transmitted through a general-purpose computer interface of a serial communication system such as an RS-232C (Recommended Standard 232 version C) that has been standardized by Electronic Industries Alliance.

Further, the marker detection units 108L and 108R, the position and orientation measurement units 109L and 109R, and the image generation units 110L and 110R are achieved by software running in the general-purpose computer.

Furthermore, each of the display image input units 104L and 104R is equivalent to a receiver that converts the high-speed transmission signal into a general digital signal.

For example, an interface in the LVDS, a TMDS (Transition Minimized Differential Signaling) or the like is equivalent to each of the display image input units 104L and 104R. Likewise, each of the captured image output units 105L and 105R is an interface that can achieve high-speed data transmission, and equivalent to, for example, the driver of the LVDS, the USB or the IEEE 1394.

The head mount display device 100 is equipped with the position and orientation sensor 120 so as to measure the position and orientation of the head mount display device 100. Here, it should be noted that, as the position and orientation sensor 120, one or more of a magnetic sensor, an optical sensor and an ultrasonic sensor can be arbitrarily selected as usage.

Subsequently, the outline of the operation for synthesizing the real-space image and the virtual-space image will be described hereinafter.

In the present exemplary embodiment, the head mount display device 100 transmits the image data which is parts of the image information transmitted from the imaging units 101L and 111R and necessary to recognize the position information of the markers in the real-space image, to the virtual-space image generation devices 106L and 106R, respectively.

The virtual-space image generation device 106L recognizes the position information of the marker by the marker detection unit 108L thereof, and the virtual-space image generation device 106R recognizes the position information of the marker by the marker detection unit 108R thereof. Then, the image generation unit 110L generates the virtual-space image by utilizing the recognized position information of the marker, and the image generation unit 11OR generates the virtual-space image by utilizing the recognized position information of the marker. Subsequently, the image generation unit 110L transmits the generated image information to the display image input unit 104L of the head mount display device 100 through the display image signal output unit 111L, and the image generation unit 11OR transmits the generated image information to the display image input unit 104R of the head mount display device 100 through the display image signal output unit 111R.

Subsequently, the respective constituent elements will be described in detail hereinafter.

The image signals captured by the imaging units 101L and 101R and then converted into the digital signals such as the YUV signals are input to the image synthesis processing units 103L and 103R respectively.

On the other hand, to detect the markers captured by the imaging units 101L and 101R through the image process, a part of the captured image data (i.e., only luminance (Y signal) data) is transmitted from the captured image output unit 105L to the captured image signal input unit 107L in the virtual-space image generation device 106L, and also a part of the captured image data is transmitted from the captured image output unit 105R to the captured image signal input unit 107R in the virtual-space image generation device 106R.

Here, it should be noted that the part of the captured image data is the data necessary to detect through the image process the marker captured by each of the imaging units 101L and 101R. For example, the part of the captured image data implies a part of the data amount of color data.

In the present exemplary embodiment, although only the luminance data (Y signal) is described, the present invention is not limited to this. That is, the color data in which the number of bits of the original color data has been reduced can be used.

If the marker can be discriminated in the image process, it is unnecessary to transmit all the data bits of the luminance data, whereby the data bits can be thinned out and then transmitted. Further, in addition to the color and the luminance, if a shape is changed as the marker, it is possible to further reduce the data bits.

Incidentally, even if the position information, which is a part acquired by cutting out a part of a known image, in a screen is used as the part of the image, this is acceptable if the markers captured by the imaging units 101L and 110R can be detected therefrom in the image process.

Then, the position information of the marker is detected by the marker detection unit 108L in image recognition technique or the like from the image data for marker discrimination transmitted from the captured image output unit 105L to the captured image signal input unit 107L, and also the position information of the marker is detected by the marker detection unit 108R in image recognition technique or the like from the image data for marker discrimination transmitted from the captured image output unit 105R to the captured image signal input unit 107R.

The output signal from the position and orientation sensor 120 of the head mount display device 100 is input respectively to the position and orientation measurement units 109L and 109R to estimate the position and the orientation of the respective imaging units (head mount display device 100).

The image generation unit 110L generates and arranges a predetermined CG (virtual-space image) or the like on the coordinates of the detected marker in the real-space image based on the information from the marker detection unit 108L and the position and orientation measurement unit 109L. Likewise, the image generation unit 110R generates and arranges a predetermined CG (virtual-space image) or the like based on the information from the marker detection unit 108R and the position and orientation measurement unit 109R.

Then, the acquired virtual-space image is transmitted from the display image signal output unit 111L to the display image input unit 104L such as a graphic board of the head mount display device 100. Likewise, the acquired virtual-space image is transmitted from the display image signal output unit 111R to the display image input unit 104R of the head mount display device 100.

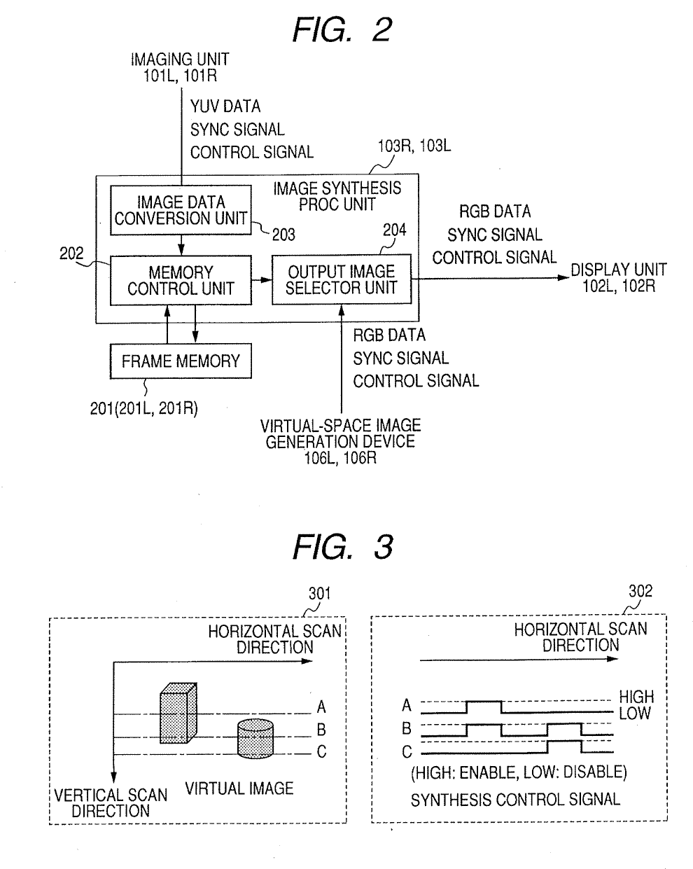

As illustrated in FIG. 2, each of the image synthesis processing units 103L and 103R includes an image data conversion unit 203 which executes YUV-RGB conversion or the like, a memory control unit 202 which controls reading/writing to/from a frame memory (storage unit) 201 such as an FIFO (First In, First Out) memory or an SDRAM (Synchronous Dynamic Random Access Memory), and an output image selector unit 204 which selects output data according to the synthesis control signal.

Here, it should be noted that the storage unit 201 stores therein the image data of the real space transmitted from the imaging unit.

In the image data conversion unit 203, the captured image signal transmitted from each of the imaging units 101L and 101R is converted into the image data having the data format of digital RGB data for the purpose of display. Here, if the resolution in the shooting/capturing system is different from the resolution in the display system, the image process such as scaling or the like is executed to the input image signal in the image data conversion unit 203.

The image data of one frame converted by the image data conversion unit 203 is then stored in the frame memory 201 (201L, 201R) under the control of the memory control unit 202 in response to a captured image sync signal.

Here, it should be noted that the image data to be stored is basically the image information which is the same as the marker data transmitted to the virtual-space image generation devices 106L and 106R for marker detection, thereby eliminating positional registration error (or misregistration) between the marker in the captured image and the CG image.

Then, the output image selector unit 204 selects and reads the captured image data (real-space image) and the virtual-space image data (virtual-space image) in the frame memory 201 in response to the synthesis control signals input respectively from the virtual-space image generation devices 106L 106R, and then outputs the display image signal to the display units 102L and 102R respectively.

Here, it should be noted that the synthesis control signals input respectively from the virtual-space image generation devices 106L and 106R is the control signals (302) for discriminating existence/nonexistence (301) of the CG generated by the virtual-space image generation devices 106L and 106R, as illustrated in FIG. 3.

That is, the control signal is set to “HIGH” if the CG exists, and set to “LOW” if the CG does not exist (301).

The image synthesis processing unit 103L selects the data (virtual-space image) on the virtual-space image side if the control signal is “HIGH”, and selects the data (real-space image) of the captured image in the frame memory 201L if the control signal is “LOW”. Likewise, the image synthesis processing unit 103R selects the data on the virtual-space image side if the control signal is “HIGH”, and selects the data of the captured image in the frame memory 201R if the control signal is “LOW”.

Although the synthesis control signal is not output on an ordinary graphic board, one bit of color data can be used as the synthesis control signal. In this case, although there is a disadvantage that the number of colors decreases, it is possible to reduce the influence by the decrease in the number of colors by using the data bit for blue as the synthesis control signal.

The display unit 102L displays a synthesis image on the liquid crystal module 102aL based on the synthesis image signal output from the image synthesis processing unit 103L. Likewise, the display unit 102R displays the synthesis image on the liquid crystal module 102aR based on the synthesis image signal output from the image synthesis processing unit 103R. Thus, an observer observes the synthesis image displayed respectively on the liquid crystal modules 102aL and 102aR through the expansion optical systems 102bL and 102bR.

As described above, according to the present exemplary embodiment, in the display system which utilizes the mixed reality that it is desirable not to use a compressed image, the image synthesis processing unit for synthesizing the captured image and the virtual-space image is provided within the video see-through head mount display device.

Thus, it is unnecessary to transmit all the image data captured by the imaging units to the virtual-space image generation device.

In other words, it only has to transmit, to the virtual-space image display and generation device, only the image data necessary to detect the position information of the marker included in the real-space image used when the virtual-space image and the real-space image are synthesized. Consequently, it is possible to shorten the data length of the image signal. Moreover, it is possible to make the transmission paths compact in size and reduce the number of the cables to be used.

### Second Exemplary Embodiment

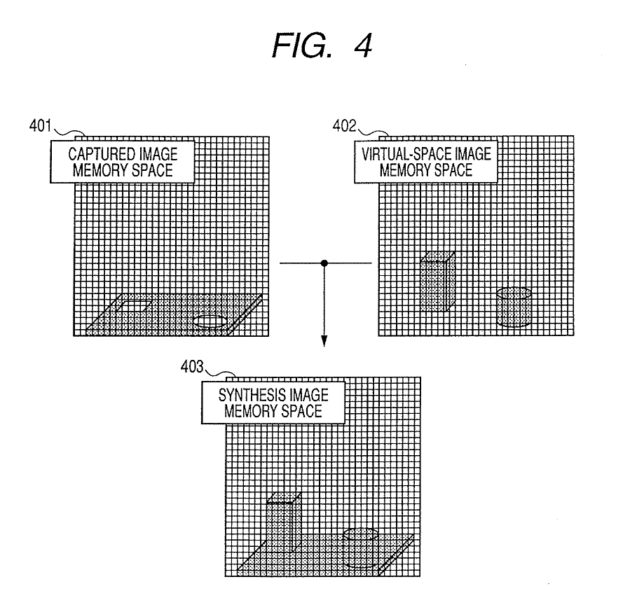

FIG. 4 is a diagram illustrating memory spaces in the second exemplary embodiment of the present invention.

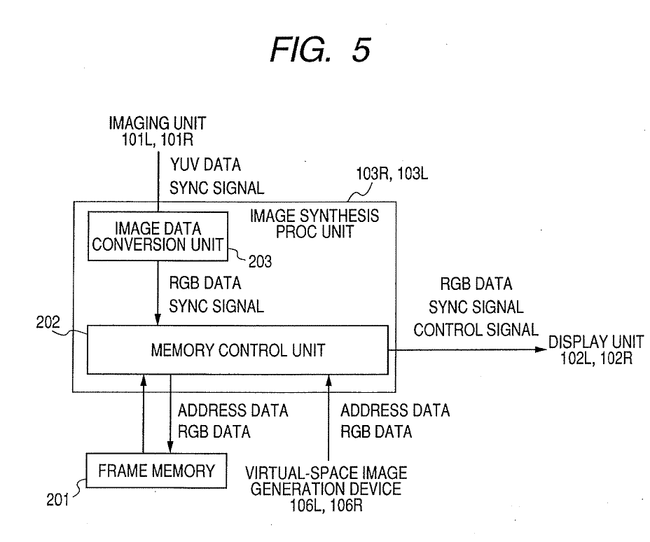

FIG. 5 is a block diagram illustrating an image synthesis processing unit in the second exemplary embodiment of the present invention.

In the first exemplary embodiment, the synthesis control signal that is output from the virtual-space image generation device is used in the image synthesis process. However, the second exemplary embodiment takes another synthesis method in which data formats of coordinate addresses and color information are used to transfer synthesis image data to the head mount display device 100. In the following, only the points different from the first exemplary embodiment will be described.

More specifically, as the constituent elements of the head mount display device 100 and the virtual-space image generation devices 106L and 106R, the image synthesis processing units 103L and 103R, the display image input units 104L and 104R and the display image signal output units 111L and 111R are different from those in the first exemplary embodiment. Accordingly, since the remaining constituent elements are the same as those in the first exemplary embodiment, the description thereof will be omitted.

With respect to the interfaces for the display image input units 104L and 104R and the display image signal output units 111L and 111R, it is necessary to provide the interfaces through which color data can be transmitted to the memory address corresponding to the virtual-space image portion.

Although depending on a data capacity for image resolution or the like, the data transmission path such as a USB or an IEEE 1394 interface corresponds to the above necessary interface. As illustrated in FIG. 5, the memory in which data can be stored at designated addresses is used for each of the image synthesis processing units 103L and 103R. Consequently, the memory control unit 202 is equipped with an interface converter which converts the interface using RGB sync signals into the interface of the frame memory 201 using addresses.

In the image synthesis operation, as illustrated in FIG. 4, a CG image (virtual-space image) 402 is overwritten on the memory (RAM) on which a captured image 401 has been written, based on the memory address and the color information data. Then, an image 403 that the CG image has been embedded in the captured image (real-space image) is generated on the frame memory 201. Subsequently, the generated images are sequentially read from the respective written locations and then transmitted to the respective display units 102L and 102R being the liquid crystal displays, whereby the synthesis image is displayed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-038154, filed on Feb. 15, 2006, which is hereby incorporated by reference herein in its entirety.

What is claimed is:

1. A display system that includes a display device and an image generation device, wherein
the display device comprises
an imaging unit adapted to capture a real-space image including a marker,
a display unit adapted to display a synthesis image which is acquired by synthesizing the captured real-space image and a virtual-space image generated by the image generation device, and
a transmission unit adapted to transmit, to the image generation device, image data which is a part of the captured real-space image and necessary to recognize position information of the marker in a real space, and
the image generation device comprises
a reception unit adapted to receive the image data transmitted from the transmission unit,
a recognition unit adapted to recognize the marker included in the received image data,
an image generation unit adapted to generate the virtual-space image based on a result of the recognition, and
an image transmission unit adapted to transmit the generated virtual-space image to the display device.

2. A display system according to claim 1, wherein
the display device further comprises a storage unit adapted to store the real-space image captured by the imaging unit, and
the display unit synthesizes the real-space image stored in the storage unit and the virtual-space image transmitted from the image generation device, by using a synthesis control signal transmitted from the image generation device.

3. A display system according to claim 1, wherein the image data is a Y signal of a YUV signal.

4. A display system according to claim 1, wherein the image data is a signal which is acquired by reducing the number of bits of an RGB signal.

5. A display system according to claim 1, wherein the display device is a head mount display device.

6. A display system according to claim 5, wherein the display device is a video see-through display device.

7. A display device comprising:
an imaging unit adapted to capture a real-space image including a marker;
a transmission unit adapted to transmit, to an image generation device, image data which is a part of captured real-space image and necessary to recognize position information of the marker in a real space;
a reception unit adapted to receive a virtual image transmitted from the image generation device;
an image synthesis unit adapted to synthesize the captured real-space image and the received virtual image; and
a display control unit adapted to display the synthesized image on a display screen.

8. A display device according to claim 7, wherein the image data is a Y signal of a YUV signal.

9. A display device according to claim 7, wherein the image data is a signal which is acquired by reducing the number of bits of an RGB signal.

10. A display device according to claim 7, wherein said imaging unit includes a charge coupled device or a CMOS imaging device.
